(19) United States
(12) Patent Application Publication
(10) Pub. No.: US 2021/0083276 A1
(43) Pub. Date: Mar. 18, 2021

(54) COMPOSITION AND METHOD FOR LAMINATION OF SILICON DOMINANT ANODES UTILIZING WATER BASED ADHESIVES

(71) Applicant: ENEVATE CORPORATION, Irvine, CA (US)

(72) Inventors: Ambica J. Nair, Irvine, CA (US); Younes Ansari, Irvine, CA (US); Frederic Bonhomme, Lake Forest, CA (US); Benjamin Park, Mission Viejo, CA (US); Sung Won Choi, San Diego, CA (US); Giulia Canton, Irvine, CA (US)

(21) Appl. No.: 16/570,311

(22) Filed: Sep. 13, 2019

(51) Int. Cl. H01M 4/38; H01M 4/04; H01M 4/62; H01M 4/66

(52) U.S. Cl. CPC H01M 4/386; H01M 4/382; H01M 4/0404; H01M 4/661; H01M 4/0435; H01M 4/622; H01M 4/0471

(57) ABSTRACT

Disclosed are anodes created using water based adhesive solutions, low temperature methods for laminating anodes comprising water based adhesives, and alkali ion batteries that comprise the anodes.

### CROSS-REFERENCE TO RELATED APPLICATIONS/INCORPORATION BY REFERENCE

N/A

### FIELD

Aspects of the present disclosure generally relate to energy generation and storage. More specifically, embodiments of the disclosure relate to lamination of a silicon dominant anode on a copper current collector utilizing a water-based thermoplastic adhesive. Embodiments include an anode made using a water-based thermoplastic adhesive and methods for using the adhesive composition as an electrode attachment substance to create silicon composite electrodes, and methods for low temperature lamination of silicon dominant anodes.

### BACKGROUND

Conventional approaches for design and manufacture of battery electrodes may be costly, cumbersome, and/or inefficient—e.g., they may be complex, resource-intensive, and/or time consuming to implement, and may limit battery lifetime and impede advancement of the technology.

Further limitations and disadvantages of conventional and traditional approaches will become apparent to one of skill in the art, through comparison of such systems with some aspects and embodiments of the present disclosure as set forth in the remainder of the present application with reference to the drawings.

### BRIEF SUMMARY

An anode made using a water-based thermoplastic adhesive, a method for using a water based adhesive composition to make an anode for alkali ion batteries, and low-temperature methods for attaching electrode active materials to current collectors substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a diagram of a battery with an anode, in accordance with an example embodiment of the disclosure.

FIG. 2 shows the effect of lamination temperature and adhesive thickness on resistance of a standard anode having a PAA/PVA composite film used as an adhesive, in accordance with an example embodiment of the disclosure.

FIG. 3 illustrates the cycle voltage profile of a battery with an anode comprising a PAA/PVA adhesive coating that attaches the current collector to the anode active material, in accordance with an example embodiment of the disclosure. Profiles for cells having PAA/PVA adhesive coatings 2 microns thick are shown and compared to cells having PAI adhesive (standard adhesive).

### DETAILED DESCRIPTION OF THE INVENTION

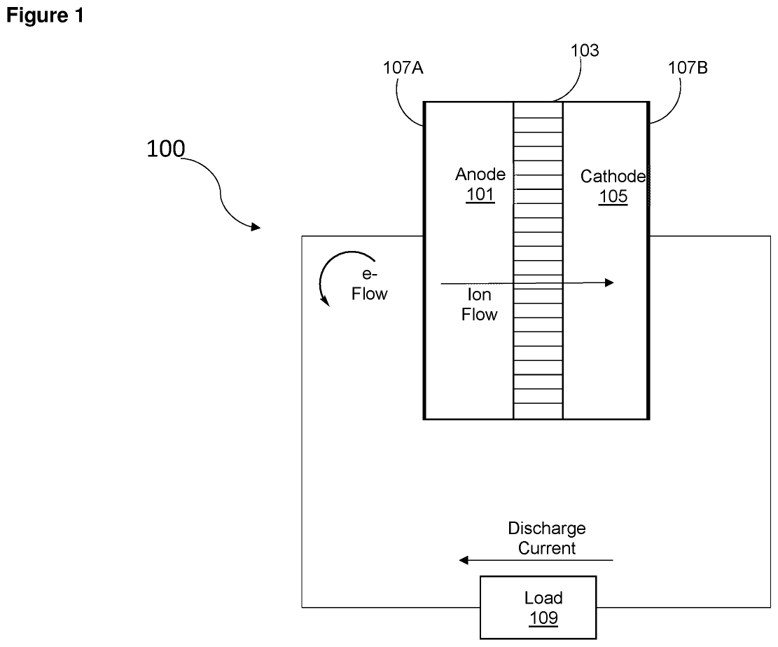

FIG. 1 is a diagram of a battery, in accordance with an example embodiment of the disclosure. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode.

The anode 101 and cathode 105, along with the current collectors 107A and 107B may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode 105 are electrically coupled to the current collectors 107A and 107B, which comprise metal or other conductive material for providing electrical contact to the electrodes as well as physical support for the active material in forming electrodes.

The configuration shown in FIG. 1 illustrates the battery 100 in discharge mode, whereas in a charging configuration, the load 107 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiA_{S}F₆, LiPF₆, and LiClO₄ etc. The separator 103 may be wet or soaked with a liquid or gel electrolyte. In addition, in an example embodiment, the separator 103 does not melt below about 100° C. to 120° C., and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in the rechargeable lithium-ion cells typically have a specific capacity of approximately 200 milliamp hours per gram. Graphite, the active material used in most lithium ion battery anodes, has a theoretical energy density of 372 milliamp hours per gram (mAh/g). In comparison, silicon has a high theoretical capacity of 4200 mAh/g. In order to increase volumetric and gravimetric energy density of lithium-ion batteries, silicon may be used as the active material for the cathode or anode. Silicon anodes may be formed from silicon composites, with more than 50% silicon, for example, which may be referred to as silicon dominant anodes.

In an example scenario, the anode 101 and cathode 105 store the ion used for separation of charge, such as lithium. In this example, the electrolyte carries positively charged lithium ions from the anode 101 to the cathode 105 in discharge mode, as shown in FIG. 1 for example, and vice versa through the separator 105 in charge mode. The movement of the lithium ions creates free electrons in the anode 101 which creates a charge at the positive current collector 1078. The electrical current then flows from the current collector through the load 109 to the negative current collector 107A. The separator 103 blocks the flow of electrons inside the battery 100.

While the battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 play a role in determining the reliability and energy density possible for the battery 100. The energy, power, cost, and safety of current Li-ion batteries needs to be improved in order to compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process cost and promote consumer safety.

A rechargeable battery (e.g., a lithium ion rechargeable battery) typically comprises an anode (negative electrode), cathode (positive electrode), separator, electrolyte, and housing. In the assembly of the electrodes, an attachment substance (e.g., adhesive or adhesive material) can be used to couple (i.e., adhere or “laminate”) an electrochemically active material (e.g., carbon, silicon carbon composite, or silicon dominant active material, including films) to a current collector, such as copper (e.g., copper sheet or foil) to form electrical contact between the components. The electrode attachment substance can adhere the active material and current collector together to prevent delamination between them. The electrode attachment substance can be placed or sandwiched between the active material and the current collector to form the electrode. The electrodes produced can include the active material (e.g., silicon carbon composite film), the attachment substance, and the current collector.

Prior electrode attachment substances include polymers such as polyamideimide (PAI), polyvinylidene fluoride (PVDF), carboxymethyl cellulose (CMC), polyacrylic acid (PAA), styrene butadiene rubber (SBR), polypyrrole (PPy), poly(vinylidene fluoride)-tetrafluoroethylene-propylene (PVDF-TFE-P), polyacrylonitrile, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, polymethylmethacrylate, polymethacrylic acid, nitrile-butadiene rubber, polystyrene, polycarbonate, and a copolymer of vinylidene fluoride and hexafluoro propylene. The electrode attachment substance is typically a thermoset polymer or a thermoplastic polymer, and may be amorphous, semi-crystalline, or crystalline. Nevertheless, and as described herein, alternative electrode attachment substances can provide for improved electrodes, methods for preparing electrodes, and batteries and battery manufacturing methods.

For example, while PAI has been successfully used as an attachment substance, it has a glass transition temperature (Tg) of about 280° C. and when used to adhere/laminate an anode active material and a current collector, requires a temperature exceeding 200° C. These relatively high process temperatures lead to higher material and process cost, and require careful protection of the current collector in order to prevent oxidation, which can lead to welding failures during cell assembly. PAI is also only soluble in specific and expensive solvents such as NMP (N-Methyl-2-Pyrrolidone).

As described and illustrated herein, use of water based adhesives as electrode attachment substances can provide low cost alternatives to materials such as PAI, and allows for the use of a non-toxic, low cost, safe, environmentally friendly solvent (e.g., water). Water-soluble polymers include, but are not limited to, polymers composed of alcohol monomers and polymers composed of carboxylic acid groups, and mixtures thereof. In some embodiments, mixtures of the two polymers may react to form a polyester. Exemplary water based adhesives are PVA (Polyvinyl alcohol) and PAA (Polyacrylic acid). PAA is a high-molecular weight polymer of acrylic acid having carboxylic acid groups that is typically a homopolymer, but which may be cross-linked with other groups (e.g., allyl ethers). PAA is inexpensive, non-toxic and readily soluble in water and has a lower Tg as compared to PAI. It has good adhesion to both silicon and copper. PVA is a linear polymer made from alcohol monomers. PVA is also inexpensive, non-toxic, readily soluble in water, and also has a lower Tg relative to PAI. It has good adhesion to silicon but poor adhesion to copper. PAA tends to absorb water due to the presence of carboxylic groups. Thus, when used in prior lamination (adhesive) methods, it could cause the silicon active material sheet to delaminate when exposed to moisture in air.

For example, utilizing water-soluble PAA as an adhesive material provides good solubility in water and good adhesion to electrode active materials such as silicon carbon composite and silicon dominant anodes relative to the attachment substances representative of the state of the art. Further, commercially available PAA typically costs less than polymers known and used as electrode attachment substances. Despite these advantages, PAA typically exhibits relatively poor adhesive properties to current collector materials over time because of moisture absorption (resulting in delamination) which has discouraged its use in such applications.

Thus, as illustrated in the disclosure and example embodiments below, making an anode with an adhesive layer composed of at least two water-soluble polymers comprising a polymer composed of alcohol monomers and a polymer composed of carboxylic acid groups provides several advantages. For example, mixtures of PAA with PVA provides an unexpected enhancement of the adhesion properties of the PAA to current collectors, such as copper, while maintaining good adhesive properties to electrode active materials and favorable Tg ranges. The PAA/PVA mixtures also have significantly lowered moisture absorption compared to PAA alone, and allows for lower lamination temperatures. The mechanism of this improved adhesion may relate to a chemical interaction (cross-linking) between PAA and PVA, which is relatively hydrophobic, while the unreacted carboxylic groups from the PAA still ensure good adhesion to copper. The reaction of PAA and PVA to form a polyester may occur at elevated temperatures, such as those used during the lamination process discussed herein.

In accordance with the disclosure, PAA, PVA, or PAA/PVA combinations can be used as electrode attachment substances. In some example embodiments, solutions of PAA and PVA are prepared in water. The solution can be applied or coated onto the current collector and/or the electrode active material (e.g., a carbon silicon composite or silicon dominant anode film). In certain example embodiments, the polymers are coated onto the current collector, such as copper (e.g., copper sheet or foil) resulting in layers having a thickness of about 1 micron to about 100 microns. For example, the coating (polymer layer) may have a thickness of about 1 micron to about 50 microns and, in some embodiments, can be from about 1 to about 10 microns when dried. In some embodiments, the polymer layer can have a final thickness of about 1, 1.5, 2, or 3 microns. In other embodiments, the polymer layer can have a final thickness of about 2, 3, or 4 microns. The coated current collector and the active material (e.g., silicon carbon composite film) can then be placed into contact with one another such that the polymer layer is sandwiched between the film and current collector. In some example embodiments, the silicon carbon composite film can be in direct contact with the current collector and the adhesive material can be between the current collector and the film at the locations where the film is not in direct contact with the current collector.

In accordance with the disclosure, when water based adhesives (e.g. PAA, PVA, or PAA/PVA combinations) are used as electrode attachment substances, lower lamination temperatures can be utilized due to the lower Tg of these materials relative to other attachment substances. Currently used materials such as PAI have higher Tg values (e.g., about 280° C.) and when used to adhere/laminate an anode active material and a current collector, require temperatures exceeding 200° C. Use of water based adhesives as disclosed herein allows for lamination temperatures of at or less than 200° C. In certain example embodiments, lamination temperatures are about 150° C., 175° C., or 190° C. In some example embodiments, lamination temperatures are between about 80° C. and 180° C. In other example embodiments, lamination temperatures are between about 90° C. and 200° C.

In some example embodiments, the electrode can include a film with an electrochemically active material on both sides of the current collector. For example, a first electrode attachment substance comprising water based adhesive(s) can be sandwiched between a first film with an electrochemically active material and a first side of the current collector, and a second electrode attachment substance (which may be the same or different water based adhesive(s)) can be sandwiched between a second film with an electrochemically active material and a second side of the current collector.

Some example embodiments can include an active material having a porosity that may range from about 1% to about 70% or about 5% to about 50% by volume porosity. In such embodiments, the water based adhesive solution may at least partially be absorbed into the porosity such that at least some of the electrode attachment substance is within the porosity of the active material (e.g., by capillary action). For example, a solution with PAA/PVA can be absorbed into the porosity, and the solution can be dried, leaving at least some amount of the PAA/PVA within the porosity of the active material. The PAA/PVA within some portion of the porosity of the active material (e.g., film) can increase the mechanical durability. As such, example embodiments can provide a composite active material that includes the PAA/PVA. In some further example embodiments, the PAA/PVA does not extend through the entire thickness of the active material. For example, a substantial portion of the active material (e.g., film) may not include, or be permeable to, a solution that includes the PAA/PVA. Thus, certain example embodiments provide for the PAA/PVA material that may only extend partially into the thickness of the active material. In these embodiments, the adhesive layer is not uniformly distributed throughout the active material layer of the electrode. In certain example embodiments, the PAA/PVA does not penetrate more than about 5 um to 10 um into the active material layer (i.e., remains near the current collector surface).

In example embodiments, the PAA/PVA is substantially electrically nonconductive (e.g., the PAA/PVA has an electrical conductivity such that, in use in an electrochemical cell, the PAA/PVA does not conduct electricity). Although the PAA/PVA may be substantially electrically nonconductive, the electrochemical cell can result in better performance than if the PAA/PVA was electrically conductive.

Pressure may be applied to press the current collector and the active material together with the water based adhesive substance between. In certain example embodiments, pressure may be applied between above atmospheric pressure (i.e., above 20 or 30 psi) to about 10000 psi, or to about 5000 psi, or about 2000 psi to about 4000 psi, or about 3000 psi to about 4000 psi. In the case of a roll press where the unit of pressure is not psi but is pounds/inch, in certain example embodiments, pressure may be applied between about 20 pounds/inch to about 2000 pounds/inch. Pressure can be applied by any method such as, for example, by putting the film, water based adhesive, and current collector through rolls such as calendaring rolls, or in a press.

An advantage to using an electrode attachment substance, i.e. water based adhesives (such as PAA, PVA, or combinations thereof), as a layer between the active material, particularly a film, and the current collector, is that the complete assembly can be more flexible than the film without the current collector and attachment substance. For example, in certain example embodiments, the active material film can be brittle and cannot be deformed (e.g., bent) significantly without cracking and failure of the film. When the same film is coupled with or attached to a current collector with the water based adhesive layer, the complete assembly can be bent or deformed to a further extent compared to a film that is not coupled with or attached to a current collector without cracking or failure of the film. In certain embodiments, the complete electrode assembly can be rolled to form a rolled-type (e.g., wound) battery.

In accordance with the disclosure, solutions in water containing PAA and PVA, and mixtures of PAA and PVA, are prepared and are capable of functioning as an electrode attachment substance that couples a current collector to an electrode active material.

As one example for preparing silicon composite electrodes utilizing water based adhesives, an amount of PAA (e.g., ˜45000 MW) is dissolved at a concentration of 7.5% (w/w) in water by heating up to 90° C. for 16 hours. In a separate vessel, an amount of PVA (e.g., ˜80000 MW) is dissolved at a concentration of 7.5% (w/w) in water by heating up to 80° C. for 16 hours. Solutions of PAA/PVA are made from these stock solutions.

In one example embodiment, 60% PAA and 40% PVA solutions (w/w) are mixed together to obtain a 1:1 ratio balance of hydroxide and proton (OH⁻ and H⁺ groups). In other example embodiments, solutions are prepared that include 50% PAA and 50% PVA and 60% PVA and 40% PAA (all expressed as (% w/w)).

In accordance with the disclosure, the PAA/PVA solutions prepared above can be used as an electrode attachment substance in the preparation of anode and/or cathodes. As an illustrative example of such a method, the PAA/PVA solutions are degassed and coated on a copper substrate (current collector) with a doctor blade and dried at 90° C. for 1 hour. The PAA/PVA layer, after drying, has a final thickness of 1, 2, or 3 microns.

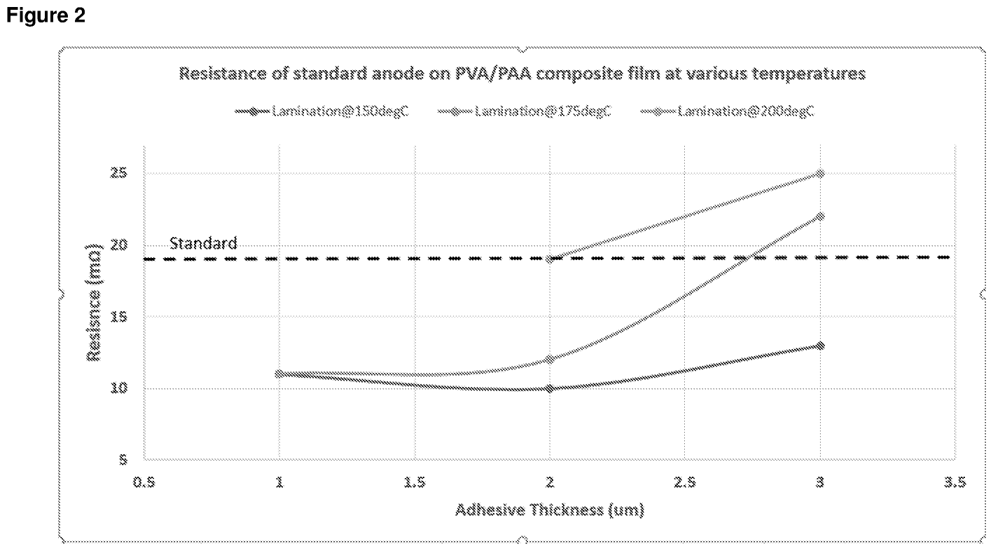

The dried coated copper substrates and a silicon carbon composite films are attached (laminated) by applying pressure (4000 psi) for 50 seconds at 150° C., 175° C. or 200° C., for example. Conductivity is measured for punched anodes (60% PAA/40% PVA) and compared to a standard anode laminated with PAI. The anode with lamination at 150° C. shows the best conductivity and, thus, the largest improvement compared to a PAI-laminated anode (see, e.g., FIG. 2). Given the data, the temperature range of about 90 degrees Celsius to about 200 degrees Celsius may be preferred in certain embodiments.

The laminated anodes are weighed immediately after lamination. They are exposed to atmosphere for, e.g., 24 hours and weighed again. The weight is measured using a microbalance, for example, and the change in weight is noted. Anodes comprising the PVA/PAA adhesives show the least % weight change due to moisture absorption, see Table 1.

TABLE 1

| Adhesive | % increase in weight |
|---|---|
| 1 - Standard anode (PAI) | 0.26% |
| 2 - 50% PVA/50% PAA | 0.21% |
| 5 - 60% PAA/40% PVA | 0.11% |

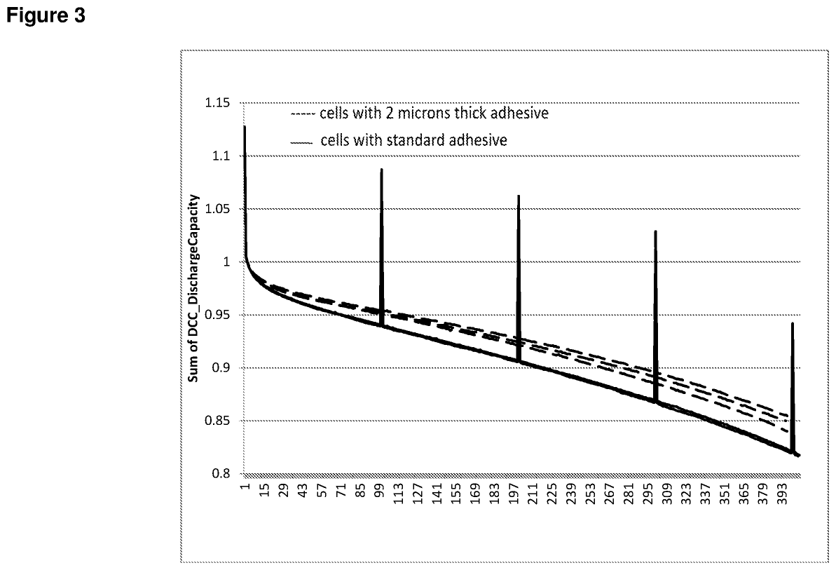

In another example embodiment, the anodes (newly laminated) are dried for, e.g., about 3 hours under vacuum and argon atmosphere, punched to form discs and assembled into coin cells. The cells also include a cathode disc comprising, for example, 92% Ni-rich lithium nickel cobalt oxide (NCA), 4% conductive carbon additive, and 4% polyvinylidene fluoride PVDF, coated on 15 micron aluminum foil with a loading of 23 mg/cm². The separator is a porous polypropylene film, for example, and the electrolyte is composed of LiPF₆ and carbonate solvents (esters), for example. The cells are cycled at, e.g., 1 C charge to 4.2V and 1 C discharge to 3.1V (see, FIG. 3).

Consistent with the above disclosure, the PAA/PVA adhesives provide several advantages relative to existing electrode attachments substances, including, for example, 1) higher conductivity anodes (>2× improvement); 2) use of non-toxic materials (PAA and PVA in environmentally friendly, low cost solvents (e.g., water)); 3) low cost materials (cost per ton of PVA/PAA solution ˜$100 compared with ˜$5000 for PAI solution); 4) lower moisture absorption (˜2× improvement); 5) low temperature processes for preparing laminated electrodes; 6) reduced oxidation of current collectors; and 7) reduced welding failures during battery assembly.

In another example embodiment of the disclosure, a method of forming an electrode is described. The method may comprise coating a current collector with a solution comprising a mixture of PAA and PVA, drying the coated current collector, and applying pressure and heat to the coated current collector and a solid film comprising electrochemically active material under conditions to adhere the coated current collector to the solid film to form the electrode. In another example, the method provides for the manufacture of an electrode that may be an anode, a silicon carbon composite anode, or a silicon dominant anode.

In another example embodiment of the disclosure, an anode is described. The anode may comprise a current collector; a solid film comprising electrochemically active material in electrical communication with the current collector, where the film comprises a silicon carbon composite film, and a layer of material between the current collector and the film, where the layer comprises a mixture of PAA and PVA that adheres the film to the current collector. In another example, the anode may be a silicon carbon composite anode, or a silicon dominant anode.

In another example embodiment of the disclosure, a method of forming a battery is described. The method may comprise providing an anode, a cathode, and a separator. The anode comprises a current collector coated with a mixture of PAA and PVA adhered to an anode substrate comprising a silicon carbon composite material. The method may further comprise assembling the cathode, the separator, and the anode, with an electrolyte to form the battery.

In another example embodiment of the disclosure, a battery is provided. The battery may comprise an anode, a cathode, an electrolyte, and a separator, where the anode comprises a current collector coated with a mixture of PAA and PVA adhered to an anode substrate comprising a silicon carbon composite material.

As utilized herein the term “battery” may be used to indicate a single electrochemical cell, a plurality of electrochemical cells formed into a module, and/or a plurality of modules formed into a pack. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a battery or device is “operable” to perform a function whenever the battery or device comprises the necessary elements to perform the function, regardless of whether performance of the function is disabled or not enabled (e.g., by a user-configurable setting, factory trim or configuration, etc.).

While the present invention has been described with reference to certain aspects, embodiments, and illustrative examples, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. An anode comprising: a current collector; a solid film comprising electrochemically active material in electrical communication with the current collector, the film comprising a silicon carbon composite film; and a layer of adhesive material between the current collector and the film, wherein the adhesive layer comprises a mixture of polyacrylic acid (PAA) and polyvinyl alcohol (PVA) that adheres the film to the current collector.

2. The anode of claim 1, wherein the silicon carbon composite film is in direct contact with the current collector and the adhesive material is between the current collector and the film at the locations where the film is not in direct contact with the current collector.

3. The anode of claim 1, wherein at least one of PAA and PVA comprises 20-80% of the total adhesive layer.

4. The anode of claim 3, wherein said adhesive layer comprises 50% PAA and 50% PVA.

5. The anode of claim 3, wherein said adhesive layer comprises 60% PAA and 40% PVA

6. The anode of claim 3, wherein said adhesive layer comprises 40% PAA and 60% PVA

7. The anode of claim 1, wherein the adhesive layer has a final thickness of about 1 microns to about 4 microns.

8. The anode of claim 1, wherein the anode is a silicon dominant anode.

9. The anode of claim 1, wherein the current collector comprises copper.

10. A method of forming an electrode comprising:
coating a current collector with a solution comprising a mixture of polyacrylic acid (PAA) and polyvinyl alcohol (PVA);
drying the coated current collector; and
applying pressure and heat to the coated current collector and a solid film comprising electrochemically active material under conditions to adhere the coated current collector to the solid film to form the electrode.

11. The method according to claim 10, wherein the coating step solution comprises 20%-80% of at least one of PAA and PVA

12. The method according to claim 10, wherein the coating step solution comprises 40% PVA and 60% PAA.

13. The method according to claim 10, wherein the drying step provides a PAA/PVA layer having a final thickness of about 1 microns to about 4 microns.

14. The method according to claim 10, wherein the drying step comprises a temperature of about 90° C. and a time of about 1 hour.

15. The method according to claim 10, wherein the applying pressure and heat comprises up to about 10000 psi of pressure at temperatures less than about 200° C.

16. The method according to claim 10, wherein the applying pressure and heat comprises about 3000-4000 psi of pressure at about 90-200° C.

17. The method according to claim 10, wherein the applying pressure is between about 20 pounds/inch to about 2000 pounds/inch.

18. The method according to claim 10, wherein the electrode is an anode.

19. The method according to claim 10, wherein the electrode is a silicon carbon composite anode

20. The method according to claim 10, wherein the electrode is a silicon dominant anode.

21. The method according to claim 10, wherein the current collector comprises copper.

22. An electrode formed by the method of claim 10.

23. A method of forming a battery, the method comprising:
providing an anode, a cathode, and a separator, the anode comprising a current collector coated with a mixture of polyacrylic acid (PAA) and polyvinyl alcohol (PVA) adhered to an anode substrate comprising a silicon carbon composite material; and
assembling the cathode, the separator, and the anode, with an electrolyte to form the battery.

24. The method according to claim 23, wherein the anode comprises a silicon dominant anode.

25. The method according to claim 23, wherein the current collector comprises copper.

26. The method according to claim 23, wherein the cathode comprises an active material comprising one or more of lithium, sodium, and potassium.

27. The method according to claim 26, wherein the cathode active material comprises lithium.

28. The method according to claim 26, wherein the cathode active material comprises lithium doped with a transition metal oxide or a non-transition metal oxide.

29. The method according to claim 26, wherein the cathode active material comprises 5% to 30% excess of lithium.

30. A battery comprising:
an anode, a cathode, an electrolyte, and a separator, wherein:
the anode comprises a current collector coated with a mixture of polyacrylic acid (PAA) and polyvinyl alcohol (PVA) adhered to an anode substrate comprising a silicon carbon composite material.

31. The battery according to claim 30, wherein the electrolyte comprises a liquid, solid, or gel.

32. The battery according to claim 30, wherein the anode comprises a silicon dominant anode.

33. The battery according to claim 30, wherein the current collector comprises copper.

34. The battery according to claim 30, wherein the cathode comprises an active material comprising one or more of lithium, sodium, and potassium.

35. The battery according to claim 34, wherein the cathode active material comprises lithium.

36. The battery according to claim 34, wherein the cathode active material comprises lithium doped with a transition metal oxide or a non-transition metal oxide.

37. The battery according to claim 34, wherein the cathode active material comprises 5% to 30% excess of lithium.
